(19) United States
(12) Patent Application Publication
(10) Pub. No.: US 2023/0347358 A1
(43) Pub. Date: Nov. 2, 2023

(54) DEVICE FOR SHREDDING STRIP-SHAPED MATERIAL AND METHOD FOR ITS OPERATION

(71) Applicant: MULTIVAC SEPP HAGGENMUELLER SE & CO. KG, Wolfertschwenden (DE)

(72) Inventors: Sebastian SAUTER, Breitenbrunn (DE); Herbert BENISCHKE, Memmingen (DE)

(73) Assignee: MULTIVAC SEPP HAGGENMUELLER SE & CO. KG, Wolfertschwenden (DE)

(21) Appl. No.: 18/141,280

(22) Filed: Apr. 28, 2023

(30) Foreign Application Priority Data
May 2, 2022 (DE) 102022110637.3

(51) Int. Cl. B02C 18/18; B02C 18/22; B02C 25/00

(52) U.S. Cl. CPC B02C 18/18; B02C 18/22; B02C 25/00; B02C 2018/188; B02C 2018/2208

(57) ABSTRACT

The disclosure relates to a device for shredding strip-shaped material comprising a housing with at least one feed opening for the strip-shaped material and a discharge opening for the shredded material, a blade holder which is mounted to be rotatable about an axis within the housing, at least one blade which is attached to the blade holder, at least one counter blade which is attached to the housing, and a drive configured to rotate the blade holder in a first direction of rotation and a second direction of rotation, opposite to the first direction of rotation, about the axis. The disclosure further relates to a method for operating a device for shredding strip-shaped material. Under the method, at least one blade holder mounted to be rotatable in a first direction of rotation, as well as in a second direction of rotation, is employed by the device.

### CROSS-REFERENCE TO RELATED APPLICATIONS

This application claims foreign priority benefits under 35 U.S.C. § 119(a)-(d) to German patent application number DE 102022110637.3, filed May 2, 2022, which is incorporated by reference in its entirety.

### TECHNICAL FIELD

The disclosure relates to a device for shredding strip-shaped material. The disclosure furthermore relates to a method for operating a device for shredding strip-shaped material.

### BACKGROUND

In deep-drawing packaging machines, a film, the so-called base film, is typically drawn off in webs from a first roll and is conveyed through the packaging machine by way of transport devices, preferably clamp chains. Film is presently understood to mean a material that is suitable for packaging foodstuffs, it can be in particular a composite film made of several plastic layers, fiber-based material, a combination of plastic and fiber-based material or the like. On its way through the deep-drawing packaging machine, the base film is treated by various stations of the deep-drawing packaging machine. One or more trays are typically formed in a forming station into the base film, and a product is then placed thereinto. A further film, the so-called top film, is supplied to the packaging process from a second roll. It is placed onto the trays and sealed in a sealing station or sealed airtight subject to vacuum and/or a modified atmosphere. The packagings produced in this way are connected as a composite by way of the base film. A combination of a transverse cutting station with a downstream longitudinal cutting station can be provided for separating the packagings from the composite of the base film and the top film. In the transverse cutting station, the composite of the base film and the top film is cut transverse to the direction of transport. The region of the film composite that is held by the clamp chains is typically not severed. The packagings are then cut in the direction of transport in the longitudinal cutting station The packagings that have now been separated drop onto a designated conveyor belt and are transported away. So-called edge strips initially remain in the clamp chains and must be disposed of as a waste product. Since the edge strips are not severed transverse to the direction of transport, they are virtually endless strips. These edge strips are specifically guided out of the clamp chains into a clamp chain deflection which is disposed in the end region of the deep-drawing packaging machine. The edge strips are typically wound up with a winding device or fed to a waste container by an extraction device. However, both devices have the drawback that they have to be emptied frequently by the operator because the edge strips are difficult to wrap or lay flat and the waste material therefore takes up a large volume in a short time. During the emptying process, the packaging machine typically has to be stopped, which significantly reduces the productivity of the system.

Shredding devices are known from DE 10 2008 039 841 A1 and DE 299 07 834 U1 for shredding the edge strips into small pieces by way of blades before they are fed to a waste container. This provides the advantage that the volume of the waste is significantly reduced and the emptying intervals can then be increased.

The requirements for packaging materials have increased steadily in recent years. There are specific packaging materials that have been specifically developed for different foods. In addition, the proportion of sustainable components in food packaging is increasing continuously. All of this means that there is a plurality of different packaging materials having different properties. The demands on a packaging machine to be able to process all the different packaging materials are also increasing. Depending on the type of packaging material, the material can be tough or brittle. Different blades are required for being able to process packaging material with different properties with a shredding device as mentioned above. If a changeover is performed in a packaging machine from one packaging material to another, e.g., a different product is to be packaged, this means that it may be necessary to change the blade of the shredding device. Furthermore, packaging films made of plastic material which are mixed with fiber-based material or packaging material made of fiber-based material are very abrasive, which leads to increased wear of the blades of the shredding device. As a result, the blades have to be replaced at shorter intervals.

Changing blades is time-consuming because the shredding device has to be opened, the old blades removed and the new blades installed and precisely adjusted. This in turn leads to undesired downtimes of the packaging machine and therefore to a loss of productivity.

### SUMMARY

Proceeding from this prior art, it is an object of the present disclosure to provide a shredding device which reduces the frequency of time-consuming changeovers and to provide a method for operating the device.

This object may be satisfied by a device according to the disclosure and by a method for its operation according to the disclosure.

The device according to the disclosure for shredding strip-shaped material, in particular packaging material, comprises a housing with at least one feed opening for the strip-shaped material and a discharge opening for the material shredded therefrom, i.e., from the strip-shaped material, a blade holder which is mounted to be rotatable about an axis within the housing, at least one blade which is attached to the blade holder, in particular in a releasable manner, and at least one counter blade which is attached to the housing, in particular in a releasable manner, and a drive which is configured to rotate the blade holder. The device according to the disclosure is characterized in that a first direction of rotation and a second direction of rotation of the blade holder about the axis, opposite to the first direction of rotation, can be determined by way of the drive. In other words, this means that the drive can rotate the blade holder either clockwise or counterclockwise for shredding the strip-shaped material that is supplied to the device. The blade holder is configured to shred the strip-shaped material regardless of its direction of rotation, making it more suitable for versatile use, especially long-term use.

In an advantageous further development of the device according the disclosure, a cutting edge of the at least one blade forms a cutting plane, which is disposed perpendicular to the axis, by a rotation of the blade holder about the axis. The cutting edge is understood to be the sharp part of the blade which causes the cutting action of the blade.

It is advantageous for a cutting gap between the at least one blade and the at least one counter-blade to be variable, in particular by adjusting the blade holder along the axis. The cutting gap refers to the minimum distance between the cutting edge of the blade and a cutting edge of the counter blade when they execute the cut together. In order to execute a reliable cutting process, it is important that the cutting gap be set correctly. Due to manufacturing inaccuracies in the blades and the counter blades as well as in the blade holder and other parts of the device, it can thus be ensured that the cutting gap can be set correctly. In addition, extremely thin or extremely thick packaging materials can require a different cutting gap for optimal cutting result.

It can be expedient to have the blade and/or the counter blade each dispose of at least two cutting edges, preferably on opposite sides. It is irrelevant whether the blade and/or counter blade each have two cutting edges or whether two blades and/or two counter blades, each with one cutting edge, are attached such that they correspond to one blade and/or counter blade with two cutting edges.

It is particularly advantageous to have the cutting edge be formed to be straight, serrated, concave and/or convex, at least in sections. Different packaging materials can sometimes be cut reliably only with different configurations of the cutting edges. For example, a serrated or wavy cutting edge is particularly suitable for cutting thin and tough packaging materials. On the other hand, brittle or even thicker packaging materials, for example, can be optimally cut with straight cutting edges.

In a further development of the device according to the disclosure, the first cutting edge and the second cutting edge can be configured to be different or identical.

It is particularly advantageous to have two counter blades be arranged on the circumference of the at least one feed opening, in particular substantially symmetrical to an imaginary center line which divides the feed opening into two regions of equal size. The imaginary center line goes through the center point of the feed opening, which corresponds to the geometric center of gravity of the feed opening, regardless of its geometry. The counter blades are arranged at the at least one feed opening such that the cutting edge of the first counter blade engages with the first cutting edge of the at least one blade in order to be able to execute a cutting process when the blade holder rotates in the first direction of rotation. And when the blade holder rotates in the second direction of rotation opposite to the first one, the cutting edge of the second counter blade engages the second cutting edge of the at least one blade such that a cutting process can be executed.

It is advantageous to have the cutting edges of the counter blades be of different or identical configuration. For example, but not in a restrictive way, the blades and counter blades can be of the same configuration. This has the advantage of using the same parts and therefore higher quantities and lower costs. If one cutting edge of a blade and counter blade is configured, for example, as a straight cutting edge and the other cutting edge as a serrated or wavy cutting edge, then the blades and counter blades can be arranged such that, when the blade holder rotates in the first direction of rotation, the respective straight cutting edges of the blades and counter blades together execute a cut and upon reversal of the first direction of rotation to the second direction of rotation, the respective serrated or wavy cutting edges of the blades and counter blades together execute a cut. This means that different packaging materials can be cut by reversing the direction of rotation. Time-consuming conversion work when changing from one packaging material to another packaging material can then be omitted. If, on the other hand, only packaging materials are processed on a packaging machine that are processed with the same embodiment of the cutting edge, then the cutting edges of all blades and counter blades can be configured in the same way. If blades or counter blades become blunt, the direction of rotation can be reversed and the device works again with a “fresh” set of cutting edges. This means that the maintenance interval for the blades can be doubled, which in turn leads to less downtime for the packaging machine and therefore to improved productivity.

According to an advantageous further development, the disclosure is characterized in that the at least one counter blade on the housing is adjustable in height and/or is tiltable. This ensures, firstly, that the cutting edges of the counter blades can always be aligned parallel to the cutting edges of the blades even in the case of manufacturing inaccuracies and, secondly, that the cutting gap can be adjusted. It is conceivable that the cutting gap that is set between the blades and counter blades that come to engage when the blade holder rotates in the first direction of rotation is different from the cutting gap of the blades and counter blades that come to engage when the blade holder rotates in the second direction of rotation. By reversing the direction of rotation of the blade holder, different cutting gaps can then be set for different packaging materials. This means that there is no need to readjust the blades and counter blades relative to one another when the packaging machine is changed over from one packaging material to another packaging material that requires a different cutting gap for reliable processing. The changeover process at the device according to the disclosure can be carried out simply by selecting the direction of rotation. This increases the productivity of the packaging machine because downtimes are prevented.

It is of particular advantage to have a negative pressure be applicable to the discharge opening. The negative pressure can be generated by a negative pressure generating device, for example, an extraction unit. Due to the negative pressure and the resulting volume flow, the strip-shaped material can be conveyed through the feed opening into the housing and the packaging material shredded therefrom can be removed from the housing in a reliable process and fed to a waste container. In addition, the strip-shaped material is kept “tight” by the volume flow, which improves the cutting result.

The disclosure also relates to a method for operating a device for shredding strip-shaped material, in particular packaging material. According to the disclosure, at least one blade holder mounted to be rotatable in a first direction of rotation as well as in a second direction of rotation opposite to the first direction of rotation is employed by the device for shredding the strip-shaped material. In the disclosure, the strip-shaped material is shredded by way of a blade holder, and regardless of whether the latter rotates in the first or in the second direction of rotation. With a rotating blade holder, which shreds the strip-shaped material that it is fed in the first as well as in the opposite, second direction of rotation, reduced service intervals are caused for the shredding device, which means that the shredding process can be more sustainable overall and can be more economical, in particular for the operation of a packaging machine.

A further development of the method according to the disclosure is characterized in that the speed of rotation is changed by way of a control device for adjusting the size of the shredded material. The selection of the optimal speed of rotation and thereby also the optimal cutting speed can vary from packaging material to packaging material. The optimal speed of rotation can therefore be selected for each packaging material. In addition, the size of the shredded material can be adjusted by selecting the speed of rotation. The faster the speed of rotation, the smaller the shredded material becomes. A heavily shredded material has the advantage of low packing density, which means that more shredded material can be accommodated in a waste container because there are fewer hollow spaces between the individual pieces of material. As a result, the interval at which the waste container must be emptied can be increased, resulting in less downtime for the packaging machine and therefore to higher productivity. If, on the other hand, the speed of rotation is reduced, fewer cuts are executed during the same time interval. This leads to less wear and tear on the blades and therefore to fewer maintenance intervals and lower consumption of wear parts and thus to lower costs.

It has proven to be particularly advantageous to have the control device store operating parameters of the device, preferably the direction of rotation and/or the speed of rotation, in a data memory, in particular in the control device. Operating parameters can be understood to mean all parameters that are necessary for the operation of the device. All the operating parameters of the packaging machine or the food processing line, hence including those of the device, that are necessary to produce a specific product are stored in a recipe.

Packaging machines or also food processing lines can be configured to produce different products. If the operator wants to change over from manufacturing one product to another product, he can change the recipe in the control device, i.e., by activating the recipe in the control device, and assign the necessary operating parameters to the entire packaging machine or food processing line, in particular specify the direction of rotation for the blade holder at the shredding device. He does not have to determine the settings for each individual station or device of a packaging machine or food processing line separately, but can do this collectively.

The application furthermore relates to a packaging machine, in particular a deep-drawing packaging machine, which comprises the device according to the disclosure and/or to a packaging machine, in particular a deep-drawing packaging machine, which is configured to carry out the method according to the above explanations.

### BRIEF DESCRIPTION OF THE DRAWINGS

An advantageous embodiment of the disclosure is illustrated in more detail hereafter with reference to a drawing, where:

FIG. 1 shows a schematic view of a deep-drawing packaging machine;

FIG. 2 shows a sectional illustration of an embodiment of a device for shredding strip-shaped material;

FIG. 3 shows a sectional illustration of the embodiment of the device;

FIG. 4 shows a detailed sectional illustration of the embodiment of the device;

FIG. 5 shows a perspective sectional illustration of the embodiment of the device;

FIG. 6 shows a perspective sectional illustration of the embodiment of the device; and

FIG. 7 shows a schematic illustration of a food processing line.

### DETAILED DESCRIPTION

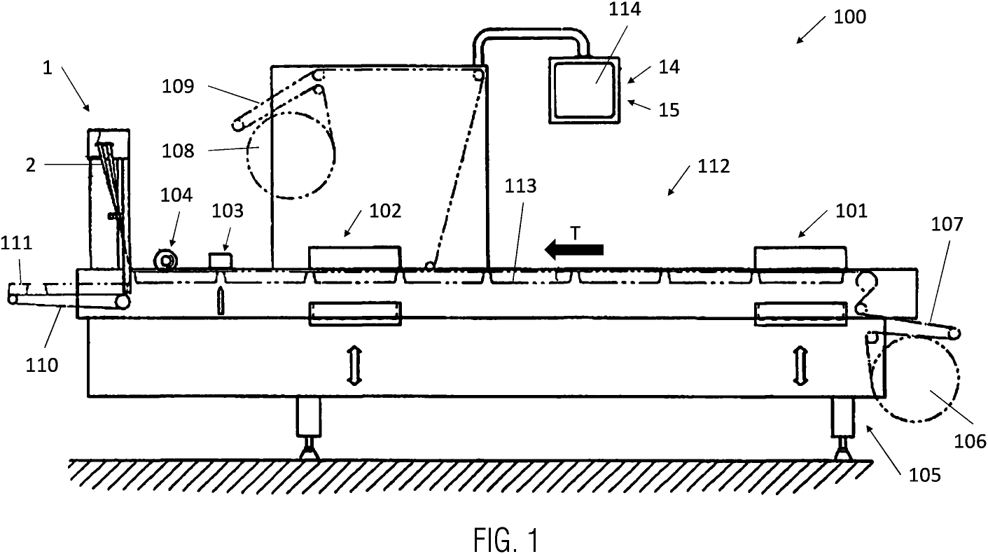

FIG. 1 schematically shows an embodiment of a deep-drawing packaging machine 100. Deep-drawing packaging machine 100 comprises a forming station 101, a sealing station 102, a transverse cutting station 103, and a longitudinal cutting station 104, as well as a device 1 for shredding strip-shaped material 2. They are arranged in the sequence mentioned in a direction of transport T on a machine frame 105.

Provided on machine frame 105 on the inlet side is a feed roll 106 from which a first film 107, the so-called base film, is drawn off. Provided in the region of sealing station 102 is a second roll 108 from which a second film 109, the so-called top film, is drawn off. Provided on the outlet side at deep-drawing packaging machine 100 is a conveyor belt 110 with which finished and separated packagings 111 are transported away. Furthermore, deep-drawing packaging machine 100 has an advancing device, not shown, which can grip base film 107 and transport it onward intermittently in direction of transport T, preferably in a main work cycle. The advancing device can be realized, for example, by laterally arranged transport chains, preferably clamp chains.

As shown in the embodiment illustrated, forming station 101 is configured as a deep-drawing station. In the latter, one or more packaging trays 113 are formed into first film 107 by deep-drawing.

Forming station 101 can be configured such that several packaging trays 113 can be formed next to one another in a direction perpendicular to direction of transport T. A loading stretch 112 is provided in direction of transport T downstream of forming station 101. Packaging trays 113 formed in base film 107 are there filled with products (not illustrated).

In sealing station 102, an atmosphere in packaging trays 113 can be removed prior to sealing, for example, by vacuuming and/or be replaced with a replacement gas or with a replacement gas mixture by gas flushing. Or sealing station 102 only closes packaging trays 113 with top film 109 without changing the atmosphere inside packaging trays 113.

Transverse cutting station 103 is configured to sever base film 107 and top film 109 in a direction transverse to direction of transport T between adjacent packaging trays 113. Transverse cutting station 103 is configured such that base film 107 is not separated across the entire width, rather is not severed at least in an edge region. This enables the film composite to be transported onward in a controlled manner by the advancing device.

Like in the embodiment illustrated, longitudinal cutting station 104 is configured as a rotating circular blade assembly with which base film 107 and top film 109 are severed between adjacent packaging trays 113 and at the lateral edge of base film 107, as a result of which individual packagings 111 are present downstream of longitudinal cutting station 104. Initially, only so-called edge strips, which are present as strip-shaped material 2, remain in the advancing device. In the end region of deep-drawing packaging machine 100, they are conveyed out of the advancing device and supplied to device 1.

Deep-drawing packaging machine 100 furthermore contains a control device 14 which has a data memory 15. Control device 14 is configured to control and/or monitor the processes running in deep-drawing packaging machine 100. In addition, a display and operating device 114 is provided preferably with control elements (not shown) and set up to visualize or influence process sequences in packaging machine 100 for or by an operator.

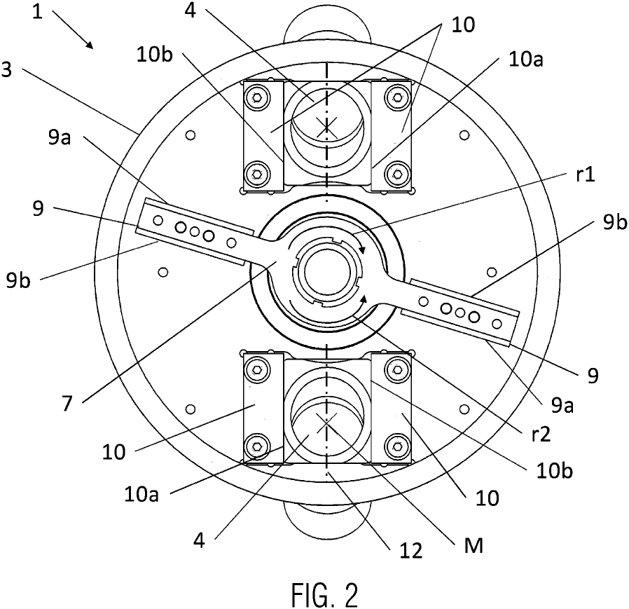

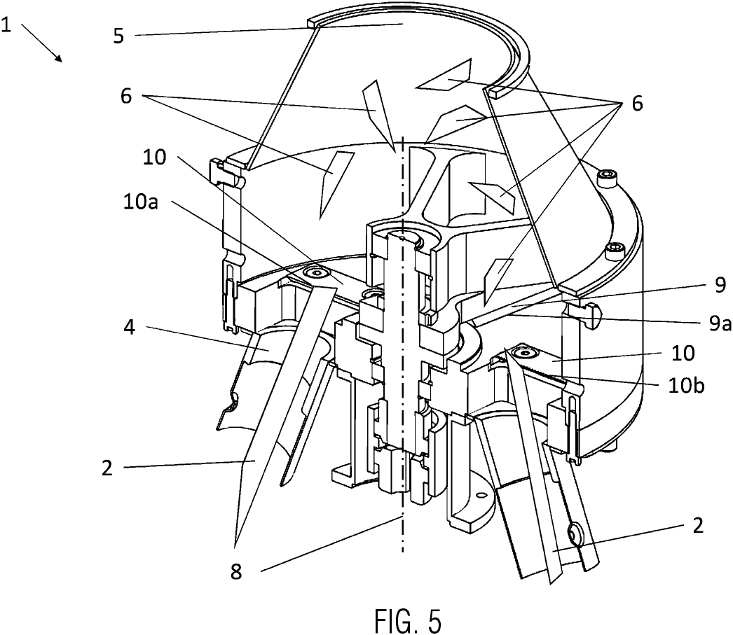

FIG. 2 shows an embodiment of device 1 according to the disclosure in a sectional illustration in a top view. Disposed at the center of a housing 3 is a blade holder 7 mounted to be rotatable and which is equipped with two blades 9 in this embodiment. First direction of rotation r1 or second direction of rotation r2, which is directed opposite to the first one, can be specified. Blades 9 each have two cutting edges 9a, 9b. Cutting edges 9a, 9b are there aligned such that cutting edges 9a are directed in first direction of rotation r1 and cutting edges 9b are directed in second direction of rotation r2. In addition, device 1 has a total of four counter blades 10, two of which are placed at feed openings 4. Counter blades 10 are arranged at feed openings 4 such that they are each disposed symmetrically with respect to a center line 12 which extends through a center point M of feed opening 4. In the embodiment shown, counter blades 10 have only one cutting edge 10a, 10b. A counter blade 10 with a cutting edge 10a and a counter blade 10 with a cutting edge 10b are each placed at a feed opening 4. And are arranged such that a strip-shaped material 2 (shown in FIG. 5) can be supplied through feed opening 4 and is shredded by cutting edges 9a, 10a when first direction of rotation r1 is selected and is shredded by cutting edges 9b, 10b when second direction of rotation r2 is selected.

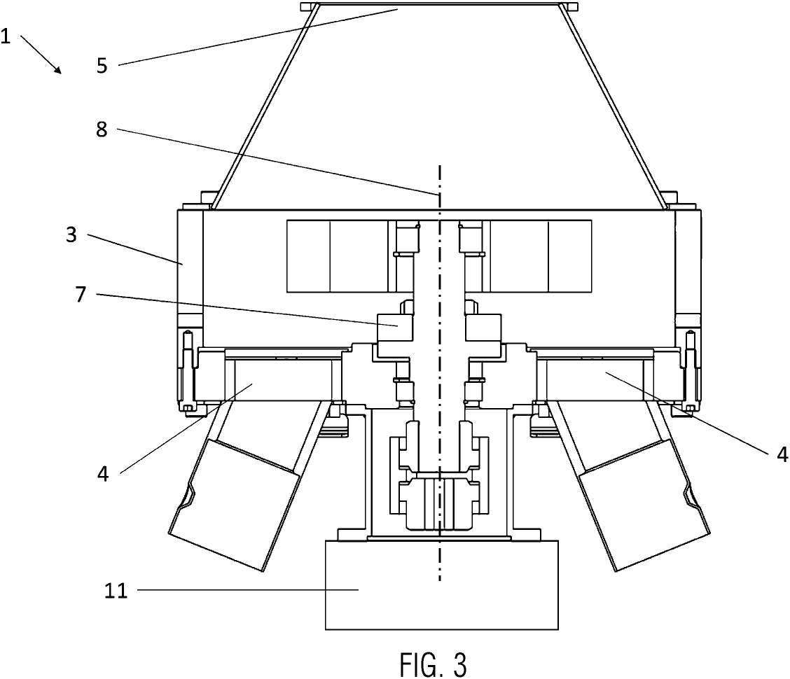

FIG. 3 shows an embodiment of device 1 according to the disclosure in a sectional illustration in a side view. A drive 11 (e.g., an electric motor provided with or without an associated controller or control device) drives blade holder 7 which is mounted to be rotatable about an axis 8. Housing 3 has two feed openings 4 and one discharge opening 5.

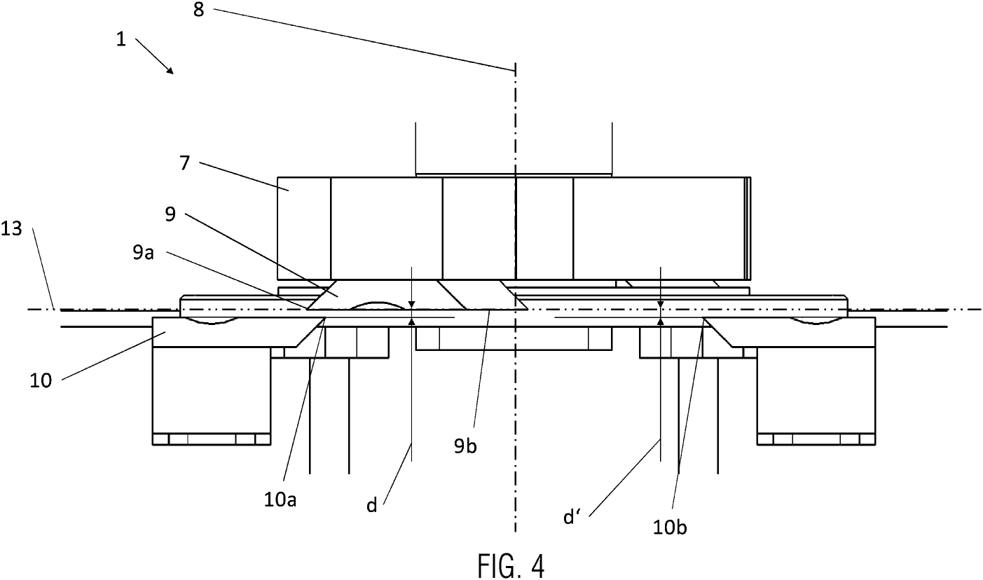

FIG. 4 shows a detailed view of a region of blades 9 and counter blades 10 of an embodiment of the device according to the disclosure. A cutting plane 13 runs perpendicular to axis 8 and through cutting edges 9a, 9b of blades 9. A cutting gap d forms between cutting plane 13 and cutting edges 10a of counter blades 10. Cutting gap d between cutting edges 9a, 10a can differ from a cutting gap d′ of cutting edges 9b, 10b.

FIG. 5 shows a sectional illustration of an embodiment of device 1 according to the disclosure in a perspective view. Strip-shaped material 2 is conveyed through feed opening 4 by way of negative pressure applied to discharge opening 5. Strip-shaped material 2 is there still held by the advancing device and a respective length of strip-shaped material 2 is released with each main work cycle of the deep-drawing packaging machine. Due to the rotation of blade holder 7 about axis 8, strip-shaped material 2 is shredded into shredded material 6 by a cutting process using blades 9 and counter blades 10. Shredded material 6 is conveyed out through discharge opening 5 by the negative pressure applied.

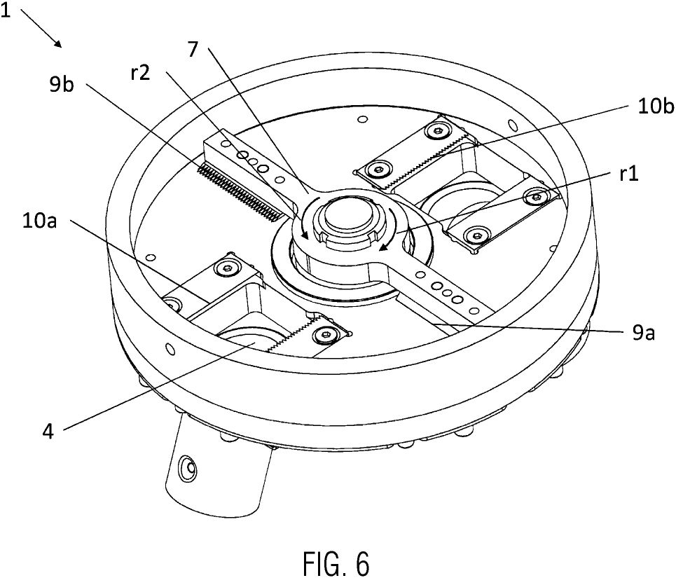

FIG. 6 shows a sectional illustration of an embodiment of the device according to the disclosure. In this embodiment, cutting edges 9a, 10a are formed as straight cutting edges and cutting edges 9b, 10b as serrated cutting edges. When blade holder 7 rotates in first direction of rotation r1, the cutting process is executed by the interaction of cutting edges 9a and cutting edges 10a; when blade holder 7 rotates in second direction of rotation r2, the cutting process is executed by the interaction of cutting edges 9b and cutting edges 10b. Cutting edges 9b, 10b in a serrated embodiment are typically particularly suitable for cutting thin and tough packaging material, and cutting edges 9a, 10a in a straight embodiment are particularly suitable for cutting thick and brittle packaging material.

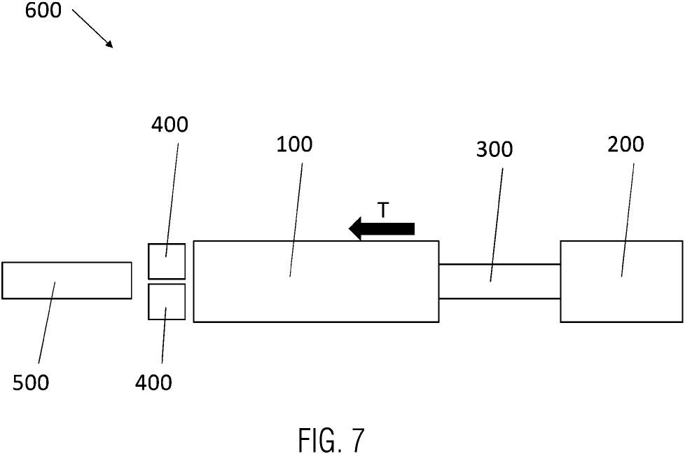

FIG. 7 shows a schematic illustration of an embodiment of a food processing line 600. It comprises a food slicing machine 200, a transport system 300, deep-drawing packaging machine 100, handling modules 400, and a final packaging system 500.

As those skilled in the art will understand, the control device 14, the drive 11, as well as any other controller, unit, component, module, system, subsystem, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC) or Electronic Control Unit (ECU), or several processors and various circuitry and/or hardware may be distributed among several separate components, whether individually packaged or assembled into a System-on-a-Chip (SoC).

REFERENCE CHARACTERS

| | |
|---|---|
| 1 | device |
| 2 | strip-shaped material |
| 3 | housing |
| 4 | feed opening |
| 5 | discharge opening |
| 6 | shredded material |
| 7 | blade holder |
| 8 | axis |
| 9 | blade |
| 9a, 9b | blade cutting edges |
| 10 | counter blade |
| 10a, 10b | counter blade cutting edges |
| 11 | drive |
| 12 | center line |
| 13 | cutting plane |
| 14 | control device |
| 15 | data memory |
| 100 | deep-drawing packaging machine |
| 101 | forming station |
| 102 | sealing station |
| 103 | transverse cutting station |
| 104 | longitudinal cutting station |
| 105 | machine frame |
| 106 | feed roll |
| 107 | base film |
| 108 | second roll |
| 109 | top film |
| 110 | conveyor belt |
| 111 | packaging |
| 112 | loading stretch |
| 113 | packaging tray |
| 114 | display unit |
| d, d′ | cutting gap |
| r 1 | first direction of rotation |
| r 2 | second direction of rotation |

What is claimed is:

1. A device for shredding strip-shaped material, comprising a housing with at least one feed opening for the strip-shaped material and a discharge opening for material shredded therefrom, a blade holder which is mounted to be rotatable about an axis within the housing, at least one blade which is attached to the blade holder, at least one counter blade which is attached to the housing, and a drive configured to rotate the blade holder in a first direction of rotation and a second direction of rotation, opposite to the first direction of rotation about the axis.

2. The device according to claim 1, wherein the at least one blade has a cutting edge that forms a cutting plane, which is disposed perpendicular to the axis, by a rotation of the blade holder about the axis.

3. The device according to claim 1, wherein a cutting gap between the at least one blade and the at least one counter blade is variable.

4. The device according to claim 1, wherein each of the at least one blade and/or each of the at least one counter blade have/has at least two cutting edges.

5. The device according to claim 4, wherein each cutting edge is formed to be straight, serrated, concave, and/or convex, at least in sections.

6. The device according to claim 4, wherein the at least two cutting edges comprise a first cutting edge and a second cutting edge, and wherein the first cutting edge and the second cutting edge are configured to be different or identical.

7. The device according to claim 1, wherein the at least one counter blade comprises two counter blades that are arranged on a circumference of a feed opening of the at least one feed opening.

8. The device according to claim 7, wherein cutting edges of the two counter blades are configured to be different or identical.

9. The device according to claim 7, wherein the two counter blades are arranged substantially symmetrical to an imaginary center line which divides the feed opening into two regions of equal size.

10. The device according to claim 1, wherein the at least one counter blade is attached to the housing to be adjustable in height and/or tiltable.

11. The device according to claim 1, wherein negative pressure is applicable to the discharge opening.

12. The device according to claim 1, wherein the at least one blade is attached to the blade holder in a releasable manner, and the at least one counter blade is attached to the housing in a releasable manner.

13. A packaging machine comprising the device according to claim 1.

14. A food processing line comprising the packaging machine according to claim 13.

15. A method for operating a device for shredding strip-shaped material, the method comprising employing, by the device, at least one blade holder mounted to be rotatable in a first direction of rotation as well as in a second direction of rotation opposite to the first direction of rotation for shredding the strip-shaped material.

16. The method according to claim 15, further comprising changing speed of rotation of the at least one blade holder by way of a control device for adjusting size of a shredded material.

17. The method according to claim 16, wherein the control device stores operating parameters of the device in a data memory.

18. The method according to claim 17, wherein the operating parameters comprise direction of rotation and/or speed of rotation.
